(19) United States
(12) Patent Application Publication
(10) Pub. No.: US 2022/0365203 A1
(43) Pub. Date: Nov. 17, 2022

(54) APPARATUS AND METHOD FOR GENERATING, MEASURING, AND RECORDING THE ACOUSTIC-RADAR RESPONSE OF ELECTRONIC DEVICES

(71) Applicants: Gregory J. Mazzaro, Charleston, SC (US); Bart H. Knapp, Charleston, SC (US); Kyle A. Gallagher, Silver Spring, MD (US); Kelly D. Sherbondy, Burke, VA (US)

(72) Inventors: Gregory J. Mazzaro, Charleston, SC (US); Bart H. Knapp, Charleston, SC (US); Kyle A. Gallagher, Silver Spring, MD (US); Kelly D. Sherbondy, Burke, VA (US)

(21) Appl. No.: 17/321,557

(22) Filed: May 17, 2021

(51) Int. Cl. G01S 13/88

(52) U.S. Cl. CPC G01S 13/887

(57) ABSTRACT

Apparatuses and methods for studying and recording acoustic/electromagnetic responses of devices that contain electrical or electronic circuits help to improve the effectiveness of detecting and characterizing electronics used with an acoustic radar. The apparatuses and methods generate, measure, and record the interactions of electromagnetic (EM) and acoustic waves at or inside those devices that are to be detected using acoustic radar.

### GOVERNMENT INTEREST

The embodiments herein may be manufactured, used, and/or licensed by or for the United States Government without the payment of royalties thereon.

### BACKGROUND

### Technical Field

The embodiments herein generally relate to apparatuses and methods for generating, measuring, and recording the acoustic-radar response of electrical or electronic devices.

### Description of the Related Art

Acoustic radar is a technology being considered for detecting concealed threats which contain electronics. In existing acoustic radars, the electromagnetic transceiver portion includes a pair of antennas which illuminate the target with electromagnetic (EM) energy and receive the acousto-electromagnetic (acousto-EM) response, respectively; and speakers are used to apply acoustic waves to the target.

Prior acousto-EM systems use antennas and speakers/thumpers to generate target responses. Coupling of EM energy from antennas to targets over-the-air is generally very inefficient due to the loss incurred when EM waves propagate from one medium into another (e.g. from the antenna, to the air, to the target, back to the air, back to the antenna). Coupling of acoustic waves from speakers/thumpers to targets is also generally very inefficient for the same reason. Also, high-power acoustic signals transmitted over-the-air often arrive at the target heavily distorted. Accordingly, there is a need for a system for measuring, characterizing, and cataloging the acousto-EM responses of metal or electronics containing targets that avoids the drawbacks of prior acousto-EM systems.

### SUMMARY

In view of the foregoing, the embodiments herein allow the user to study how electronic targets respond to simultaneous excitation by EM and acoustic waves, inside of a well-controlled bench-top environment. If such targets, when placed inside this apparatus, do produce a measurable acousto-EM response, that response may be captured and catalogued. The existence of an acousto-EM response from a particular target indicates that the target may be detected by a fully standoff acoustic radar. Referencing those responses captured and catalogued using the embodiments herein, that target may also be identified by the radar. Thus, the embodiments herein will enhance the capabilities of acoustic radar in the detection and characterization of concealed threats which contain electronics.

Some embodiments herein are directed to an apparatus that uses an open-waveguide structure to apply an EM wave to a target device while simultaneously applying an acoustic wave to that target device. The target device may be an electronic device for example. The apparatus employs an acoustic exciter (a.k.a. modal thruster) system that uses a non-conductive support bar or rod to shake the target device at an acoustic frequency. The apparatus employs a unique mechanical solution for coupling the thruster or driver member of the acoustic exciter to the non-conductive support bar, and for coupling the non-conductive support bar to the target device. The coupling between the driver member of the acoustic exciter and the support bar uses a fastener with two threaded portions. A first threaded portion of the fastener engages the driver member of the acoustic exciter, and a second threaded portion engages the support bar. A locknut or “jam nut” placed on the first threaded portion of the fastener is used to securely hold the support bar, and in turn the target device, in any desired or selected rotational position about the longitudinal axis of the support bar.

Using an open-wall waveguide to couple EM energy into the target allows the user to precisely control the EM energy applied to the target. Also, because the waveguide is open-wall, there is ample space for an acoustic exciter, using a support bar to support the target inside the waveguide, to directly inject acoustic energy into the target at the same time that the target is illuminated by EM energy.

The embodiments herein are not limited to the operating band of a particular speaker/thumper unit. In the embodiments herein, the acoustic signal is not distorted by nonlinear acoustic effects which would appear if an equivalent vibrational energy were transmitted to the target by a speaker/thumper.

In some embodiments herein, the waveguide and the acoustic exciter are placed on physically-separate platforms. Also the platform beneath the acoustic exciter is vibration dampening. In this arrangement, the vibrations of the acoustic exciter itself (aside from those transferred to the support bar) are attenuated by the vibration-dampening support and not transferred to the waveguide. The high degree of mechanical isolation between the waveguide platform and the acoustic exciter platform effectively minimizes the (acoustic) noise floor and maximizes the sensitivity of the acousto-EM apparatus.

Some embodiments herein employ a non-metallic support bar, which is minimally EM reflective, for suspending the target device within the waveguide. As the non-metallic support bar is minimally EM reflective, the acousto-EM responses generated and measured by these embodiments are attributable to the target alone (i.e., not to the acoustic-excitation portions of the apparatus).

Rather than measure the modulated EM wave output from the second port of the waveguide, embodiments herein measure the EM wave from the first port of the wave guide. By inserting the directional coupler between the RF signal generator and the waveguide, these embodiments measure the reverse-traveling wave (with respect to the forward, transmitted EM wave). Thus, these embodiments measure a wave much like it would be reflected from a target probed by an acoustic radar (back towards the radar receiver, rather than measuring the forward-traveling wave that is scattered away from the radar).

The embodiments herein allow the apparatus to be reset for each new target in under an hour. The embodiments herein enable the user to study acousto-EM (acoustic-radar) responses with a flexibility, ease, and speed unmatched by any prior art.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram illustrating the general arrangement of an acoustic radar;

FIG. 2 is a schematic diagram illustrating an apparatus in accordance with the embodiments disclosed herein;

FIG. 3 is an enlarged view of the waveguide and acoustic exciter of the apparatus in accordance with the embodiments disclosed herein;

FIG. 4 is a schematic diagram illustrating an apparatus in accordance with the embodiments disclosed herein showing the support bar, and in turn the target device, in a different rotational position about the longitudinal axis of the support bar;

FIG. 5 is a schematic diagram illustrating an apparatus in accordance with the embodiments disclosed herein showing the support bar, and in turn the target device, in a different orientation relative to the wave guide;

FIG. 6 is an enlarged view of the acoustic exciter suitable for use with some embodiments disclosed herein;

FIG. 7 is a fragmentary diagram illustrating a close-up view of the attachment of the target device to the second end of the support bar that employs a low melting point plastic that is solid at room temperature applied in a C-shaped strip about the target device;

FIG. 8 is a fragmentary diagram illustrating a close-up view of the attachment of the target device to the second end of the support bar that employs a low melting point plastic that is solid at room temperature applied in a strip that forms a complete loop about the target device; and

FIG. 9 is an illustration showing the components, in an assembled condition, that are used in some embodiments herein for attaching the support bar to the acoustic exciter;

FIG. 10 is an illustration showing the components, in a disassembled condition, that are used in some embodiments herein for attaching the support bar to the acoustic exciter;

FIG. 11 is an illustration showing the fastener that is used in some embodiments herein for attaching the support bar to the acoustic exciter;

FIG. 12 is a power vs. frequency spectrum illustrating the difference between the acousto-EM response received when a target device is present in the apparatus and the acousto-EM response received when a target device is not present in the apparatus;

FIG. 13 is a power vs. frequency spectrum illustrating the difference between the acousto-EM responses received for different target devices using an apparatus in accordance with the embodiments disclosed herein; and

FIGS. 14-20 are flow diagrams illustrating methods for characterizing the acousto-EM responses of target devices in accordance with the embodiments disclosed herein.

### DETAILED DESCRIPTION

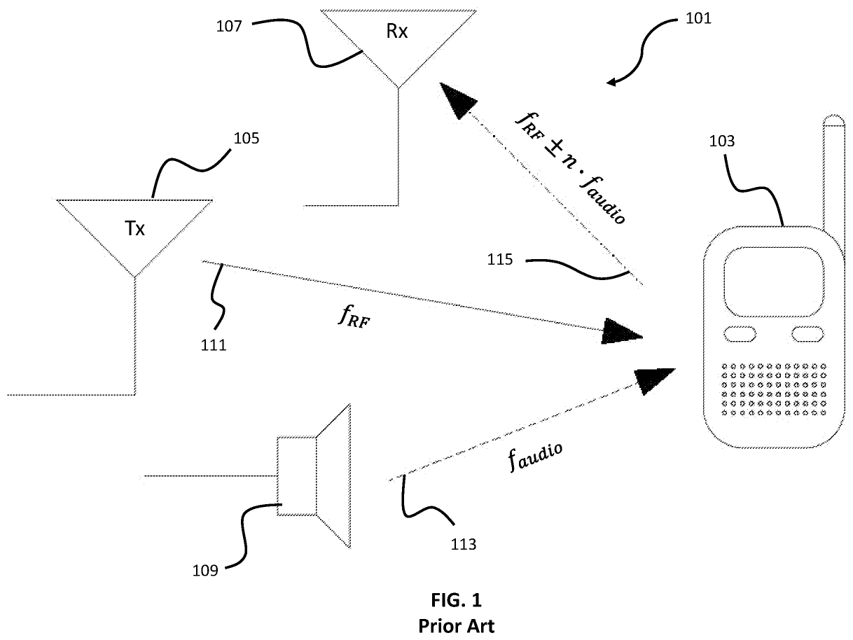

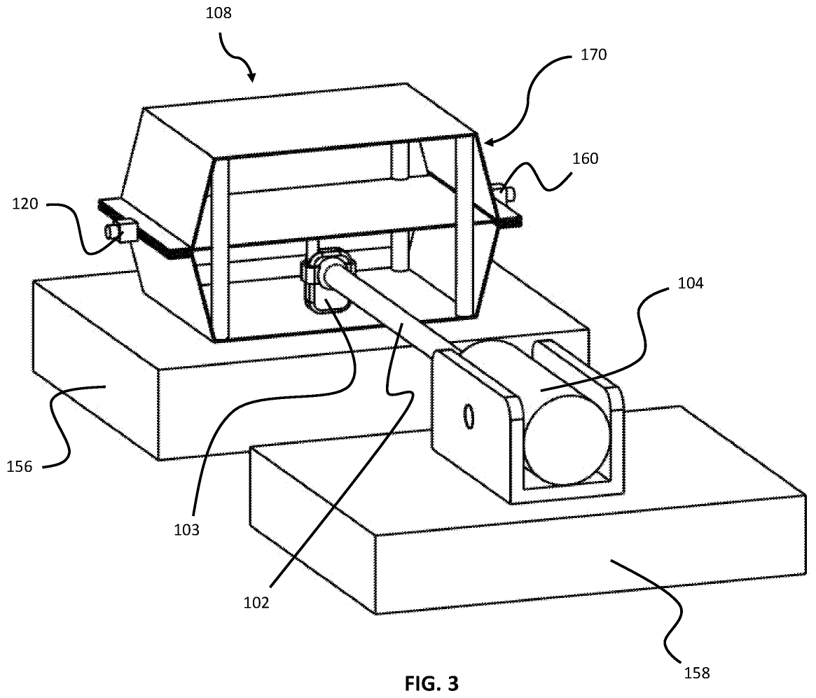

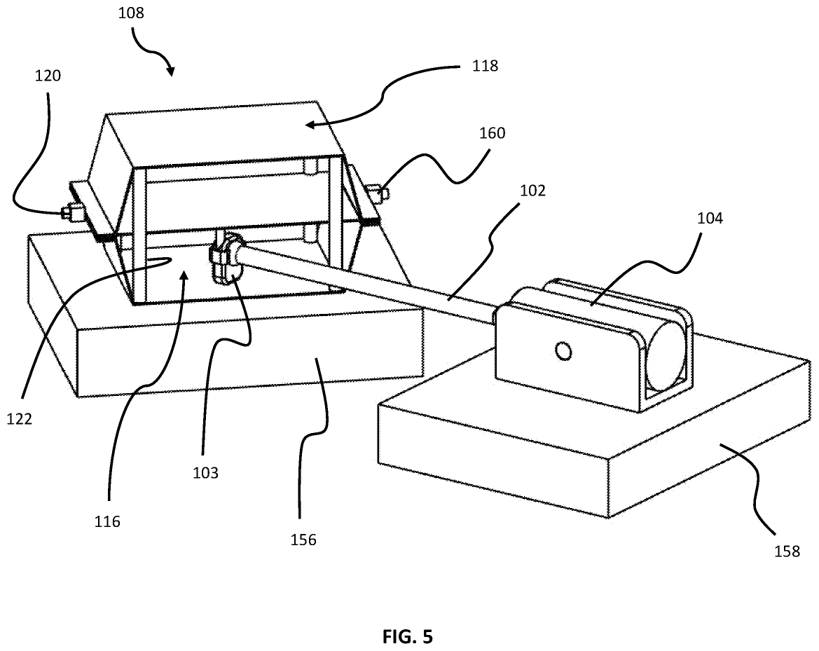

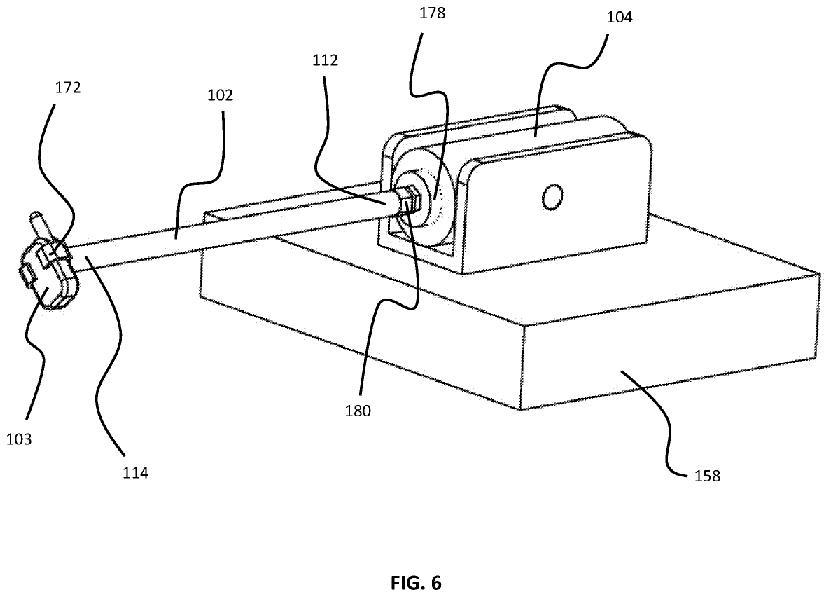

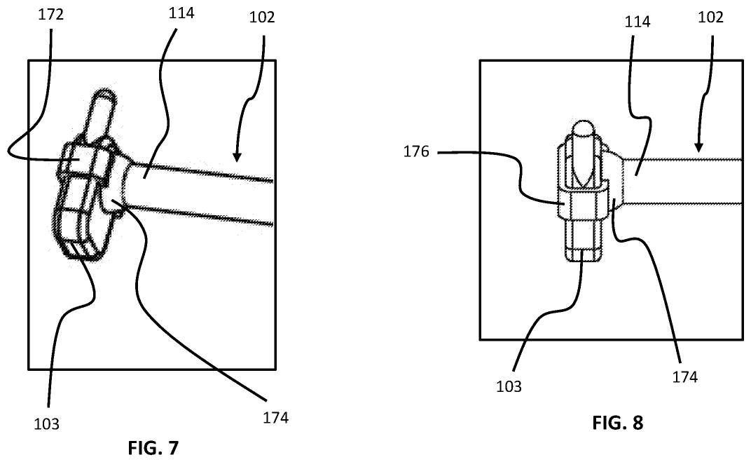

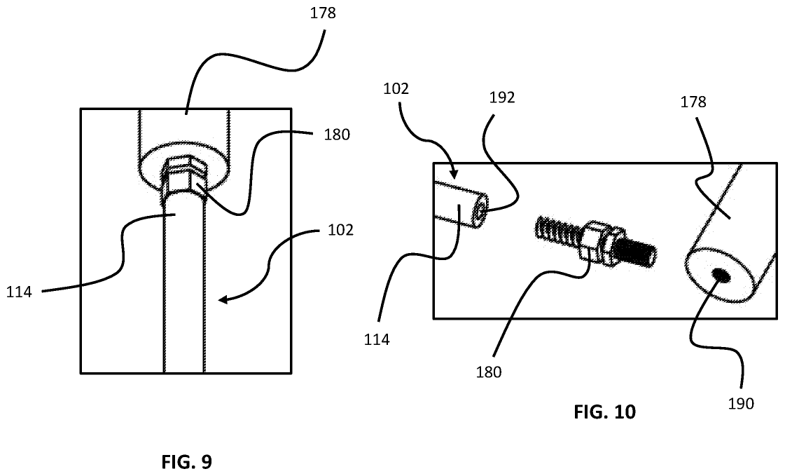

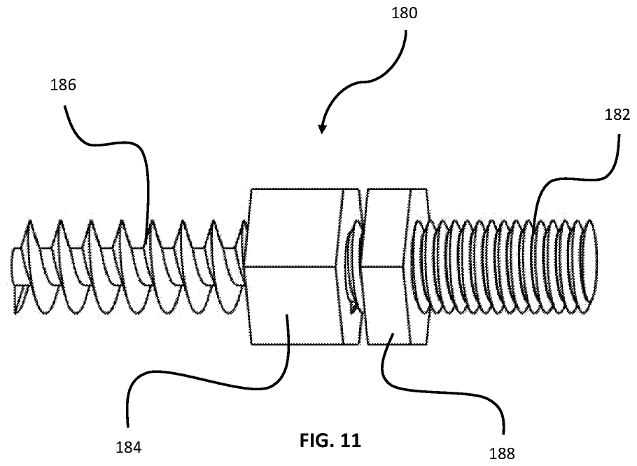

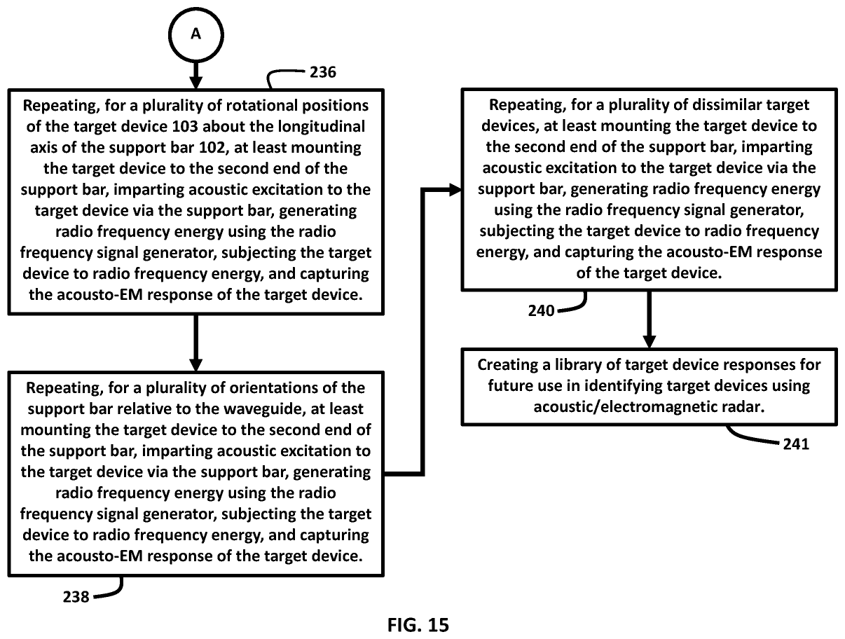

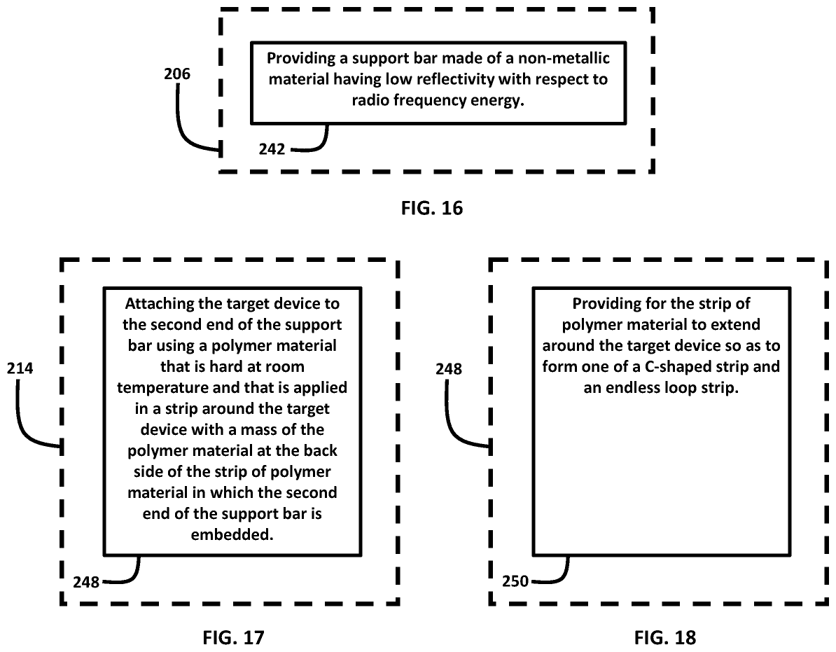

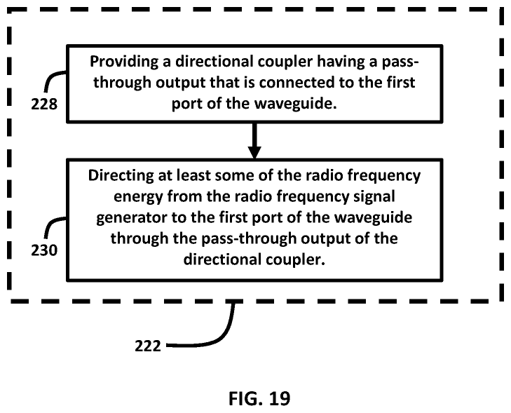

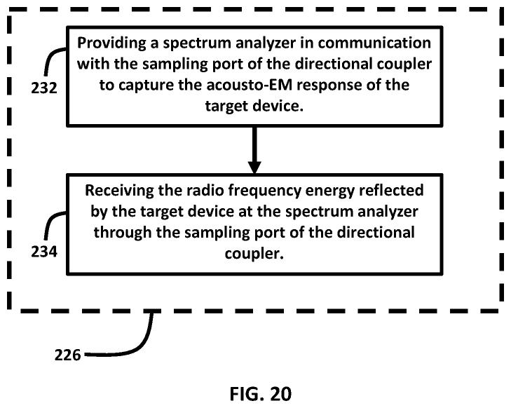

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Referring now to the drawings, and more particularly to FIGS. 1 through 20, where similar reference characters denote corresponding features consistently throughout the figures, there are shown examples of the embodiments herein. In the drawings, the size and relative sizes of components, layers, and regions, etc. may be exaggerated for clarity.

Acoustic radar is one technology being considered for detecting threats that contain conductive components such as, for example, metallic and/or electronic devices. An acoustic radar 101 is illustrated in FIG. 1. The transmitter (Tx) comprises of an electromagnetic (EM) wave generator 105 (i.e., an antenna) emitting a single radio frequency 111 (f_{RF}) and an acoustic-wave generator 109 (i.e., a speaker) emitting a single acoustic frequency 113 (f_{audio}). At the target 103, the EM wave and the acoustic wave interact. One mechanism by which the acoustic and EM waves interact is the phenomenon known as the Doppler shift. In the Doppler Shift mechanism, the conductive components of the target device shake toward and away from the radar, producing positive and negative frequency shifts at multiples of f_{audio} above and below f_{RF}. Another mechanism is metal-metal contact. In this mechanism, the conductive junctions within the target intermittently connect and disconnect, imparting abrupt changes in amplitude at a rate of f_{audio} onto the carrier frequency f_{RF}. These theories reflect current belief regarding the mechanism of operation of acoustic radar and should not be construed in any way as limiting the scope of the embodiments disclosed herein.

Because of these interactions and the radar-reflective nature of electronics and metals, the target 103 radiates a new EM wave which comprises of the original EM wave modulated by the acoustic wave. The new EM wave, i.e., acousto-EM response 115, contains a set of frequencies f_{RF}±n·f_{audio} where n is any positive integer. This acousto-EM response 115 is captured by the radar's receive (Rx) antenna 107. The presence of measurable EM energy at any discrete multiple of f_{audio} away from the original radio-frequency (RF) carrier of frequency f_{RF} (i.e., at any n≠0) indicates target detection.

Furthermore, the spectrum of power received vs. frequencies received (n=1, 2, 3, . . . ) for a particular target forms a unique signature associated with that target. By referencing a library of such spectra collected during a well-controlled a-priori acousto-EM response determination, an acoustic radar which collects similar power-vs.-frequency data may be trained to identify familiar targets, at standoff range and when those targets are concealed. Some embodiments disclosed herein provide an apparatus capable of providing the library of acousto-EM responses that are needed for an effective acoustic radar system.

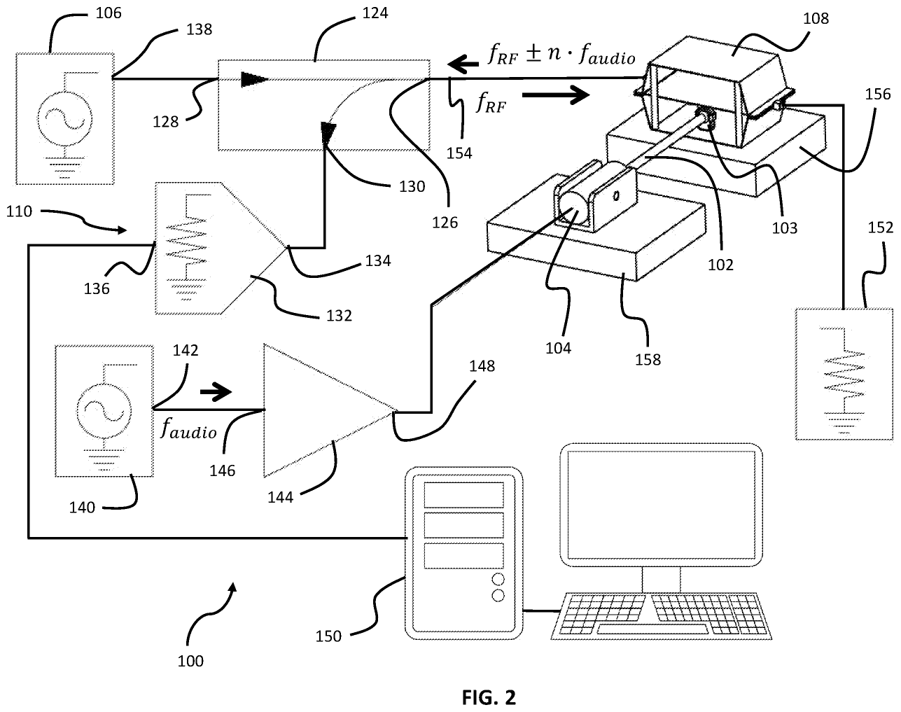

Referring to FIGS. 2-11, some embodiments disclosed herein relate to an apparatus for characterizing the acousto-electromagnetic (acousto-EM) response of a target device 103. The target device 103 comprises at least one component selected from the group consisting of metallic components, electrical components, and electronic components. The apparatus comprises a support bar 102, an acoustic exciter 104, a radio frequency signal generator 106, a waveguide 108, and means 110 for capturing the acousto-EM response of the target device 103.

The support bar 102 has a first end 112, a second end 114, and a longitudinal axis. The waveguide 108 defines an interior space 116 and an exterior space 118. The waveguide 108 has at least a first port 120. The waveguide 108 has at least one opening 122 configured to allow the second end 114 of the support bar 102 to be located within the interior space of the waveguide 108 while allowing the first end 112 of the support bar 102 to be located outside of the waveguide 108.

The second end 114 of the support bar 102 is capable of having the target device 103 mounted thereto within the interior space of the waveguide 108. The support bar 102 is connected to the acoustic exciter 104 such that the acoustic exciter 104 can impart acoustic excitation to the target device 103 via the support bar 102. The radio frequency signal generator 106 is configured for generating radio frequency energy in the form of electromagnetic (EM) waves or radiation in the radio frequency range of the electromagnetic spectrum. At least some of the radio frequency energy is directed to the first port 120 of the waveguide 108 in order to subject the target device 103 to radio frequency energy within the interior space of the waveguide 108. The radio frequency energy to which the target device 103 is subjected within the interior space of the waveguide 108 results from the radio frequency energy directed to the first port 120 of the waveguide 108 when the target device 103 is mounted to the second end 114 of the support bar 102 within the interior space of the waveguide 108.

The means 110 for capturing the acousto-EM response of the target device 103 captures the acousto-EM response of the target device 103 resulting from the acoustic excitation of the target device 103 and subjecting of the target device 103 to the radio frequency energy within the interior space of the waveguide 108.

In some embodiments herein, the apparatus further comprises a directional coupler 124 having a pass-through output 126 that is connected, via a cable 154, to the first port 120 of the waveguide 108. The directional coupler 124 directs at least some of the radio frequency energy from the radio frequency signal generator 106 to the first port 120 of the waveguide 108. The directional coupler 124 also has an input port 128, which communicates with the radio frequency signal generator 106, and a sampling port 130. The acousto-EM response of the target device 103 comprises radio frequency energy reflected by the target device 103 while the target device 103 is mounted to the second end 114 of the support bar 102 within the interior space of the waveguide 108, acoustic excitation is being imparted to the target device 103 by the acoustic exciter 104 via the support bar 102, and radio frequency energy is being imparted to the target device 103 via the waveguide 108. The acousto-EM response of the target device 103 includes a set of frequencies f_{RF}±n·f_{audio} for a plurality of values of n where each n is a positive integer. Acoustic excitation refers to mechanical vibrations, i.e., bodily vibrations, in the acoustic frequency range. The radio frequency energy reflected by the target device 103 is sampled through the sampling port 130 of the directional coupler 124 to capture the acousto-EM response of the target device 103.

In some embodiments herein, the apparatus further comprises a spectrum analyzer 132. The spectrum analyzer 132 has an input port 134 that is in communication with the sampling port 130 of the directional coupler 124 to capture the acousto-EM response of the target device 103 when the target device 103 is mounted to the second end 114 of the support bar 102 within the interior space of the waveguide 108 and is acoustically excited and is subjected to the radio frequency energy. The spectrum analyzer 132 is configured to capture the acousto-EM response of the target device 103 in the form of a frequency spectrum of power received by the spectrum analyzer 132 vs. frequency of the radio frequency energy reflected by the target device 103, which is received by the spectrum analyzer 132 through the sampling port 130 of the directional coupler 124. The power received by the spectrum analyzer 132 is based at least in part on a rate per unit time at which the radio frequency energy reflected by the target device 103 is received by the spectrum analyzer 132 through the sampling port 130 of the directional coupler 124. The spectrum analyzer 132 has an output port 136, and the spectrum analyzer 132 is configured to provide the acousto-EM response of the target device 103, in the form of the power received by the spectrum analyzer 132 vs. frequency spectrum, at the output port 136 of the spectrum analyzer 132.

In some embodiments herein, the apparatus further comprises a signal recorder 150. The signal recorder 150 communicates electrically, via a cable, with the output 136 of the spectrum analyzer 132 for capturing the acousto-EM response of the target device 103, which is received from the spectrum analyzer 132 in the form of the power vs. frequency spectrum that in turn results from the acoustic excitation of the target device 103 and subjecting of the target device 103 to the radio frequency energy via the waveguide 108, in the form of a recording for future reference. In the illustrated embodiment, the signal recorder is a computer 150 provided with the software for storing the power vs. frequency spectrum, received from the spectrum analyzer 132, in the form of a data file on any suitable memory device or storage medium. An alternative example of a signal recorder is a strip-chart recorder.

In some embodiments herein, the support bar 102 is connected to the acoustic exciter 104 using a connection configured to allow rotation of the support bar 102 about its own longitudinal axis to a user-selectable angle to allow for changing an angle of the target device 103 relative to a reference plane containing the longitudinal axis of the support bar 102. This arrangement allows the acousto-EM response of the target device 103 to be recorded at a plurality of angular orientations of the target device 103 about the longitudinal axis of the support bar 102 at each angular orientation of the longitudinal axis of the support bar 102 in three dimensional space, i.e., in relation to the three customary x, y, and z axes of three dimensional space.

In some embodiments herein, the connection between the acoustic exciter 104 and the first end 112 of the support bar 102, which is configured to allow rotation of the support bar 102 about its longitudinal axis, is provided at least in part by a fastener 180, which may be made of a composite of metallic and non-metallic materials. In some embodiments herein, the fastener 180 may be made entirely of metallic materials or entirely of non-metallic materials.

The fastener 180 has a longitudinal axis and includes a first threaded portion 182, a second threaded portion 186, and a middle portion 184 provided intermediate the first threaded portion 182 and the second threaded portion 186. The first threaded portion 182 and the second threaded portion 186 are coaxial and have longitudinal axes that are coincident with the longitudinal axis of the fastener 180. The first threaded portion 182 is provided with machine screw threads, and the second threaded portion 186 is provided with wood screw threads. Wood screw as used herein refers to a screw thread type and does not necessarily mean that the screw is intended solely for engagement to wooden objects. The middle portion 184 is adapted for engagement by a tool for rotating the fastener 180 about the longitudinal axis of the fastener, for example, to tighten the fastener or to change the rotational position of the fastener about the fastener's longitudinal axis.

In some embodiments herein, the second threaded portion 186 is attached to the middle portion 184 by having one end inserted into a hole in the corresponding end of the middle portion 184 and then fixed in place by epoxy. In some embodiments herein, the second threaded portion 186 may be attached to the middle portion 184 by being welded to the corresponding end of the middle portion 184. In some embodiments that employ welding to attach the second threaded portion 186 to the middle portion 184, the second threaded portion 186 may have one end inserted into a hole in the corresponding end of the middle portion 184 and then fixed in place by welding. In some embodiments herein, the fastener 180 may be of one-piece construction. In some embodiments herein, at least the first threaded portion 182, the middle portion 184, and the second threaded portion 186 of the fastener may be made of, for example, steel, brass, aluminum, and hard or high-impact polymers and composites.

In some embodiments herein, the middle portion 184 may be provided with flats for engagement by, for example, an open-ended wrench or an adjustable or crescent wrench. In some embodiments herein, the middle portion 184 may be provided with one or more holes, grooves, or indentations for engagement by, for example, a pin or hook spanner wrench.

In some embodiments herein, the acoustic exciter 104 has a driver member 178 that has a female-threaded hole. The first threaded portion 182 of the fastener 180 has male threads designed to match the female threads of the threaded hole 190 of the driver member 178 of the acoustic exciter 104. The first end 112 of the support bar 102 has a hole 192 that extends coaxially with the support bar 102 for a distance into the support bar 102. The second threaded portion 186 engages the hole 192 in the first end 112 of the support bar 102 to attach and fix the fastener 180 to the first end 112 of the support bar 102. The first threaded portion 182 engages the hole 190 in the driver member 178 of the acoustic exciter 104 to attach the fastener 180, and in turn the support bar 102, to the driver member 178 of the acoustic exciter 104. The fastener 180 is capable of being rotated in the hole 190 in the driver member 178 to thereby rotate the support bar 102 about its own longitudinal axis to a user-selectable angle or rotational position. A jam nut 188 is provided on the first threaded portion 182 of the fastener 180 and is tightened down against the driver member 178 of the acoustic exciter 104 to secure and fix the fastener 180, and in turn the support bar 102, in the user selected rotational angle or position about the longitudinal axis of the support bar 102.

The support bar 102 has an orientation relative to the waveguide 108 corresponding to the orientation of the direction of longitudinal axis of the support bar 102 relative to the waveguide 108. The waveguide 108 is an open wall waveguide that allows for changing of the orientation of support bar 102 relative to the waveguide 108 in order to determine the acousto-EM response of the target device 103 at a variety of angular orientations of the target device 103 relative to a direction of propagation of the radio frequency energy within the waveguide 108.

The embodiments herein isolate the response of each target 103 from the responses (noise) produced by the apparatus itself. Features that isolate the response of each target 103 from the noise produced by the apparatus include a non-metallic support bar 102, establishing rigid mechanical coupling from the metallic output of the acoustic exciter 104 to the non-metallic support bar 102, and physically separating the EM wave generator (i.e., the RF signal generator 106) and acoustic-exciter platforms 156 and 158, respectively. In some embodiments herein, the support bar 102 is made of a non-metallic material having low reflectivity with respect to the radio frequency energy. In some embodiments herein, the support bar 102 is made from one or more materials selected from the group consisting of wood, polymers, and non-metallic composite materials.

In some embodiments herein, the apparatus further comprises a separate, vibration-dampening support. The acoustic exciter 104 is supported on the separate, vibration-dampening support in order to acoustically isolate the spectrum analyzer 132 from the acoustic exciter 104 so as to reduce noise in the acousto-EM response of the target device 103 received by the spectrum analyzer 132.

In some embodiments herein, the waveguide 108 has a second port 160, and the apparatus further comprises a matched load 152 provided at the second port 160 of the waveguide 108.

Referring to FIGS. 2-11, the illustrated embodiment relates to an apparatus that includes a large waveguide 108 and a mechanical shaker 104, which is also referred to herein as a modal thruster or an acoustic exciter. The apparatus is designed for measuring the acousto-EM response of a target device 103 of interest.

The source of the EM energy which illuminates the target 103 is the radio frequency (RF) signal generator 106. It outputs a continuous-wave (CW) sinusoid at a frequency f_{RF} and a constant power P_{RF}. This CW transmit signal enters a directional coupler 124 and passes on to the waveguide 108. In the illustrated embodiment, the waveguide 108 is a transverse electromagnetic (TEM) cell. The pass-through output 126 of the directional coupler 124 is connected to the first port 120 of the waveguide 108. RF energy at frequency f_{RF} is supplied to the first port 120 of the waveguide 108 through the pass-through output 126 of the directional coupler 124. The second port 160 of the waveguide 108 is terminated in a matched load 152.

The target 103 is placed inside of the waveguide 108. In the illustrated embodiment, the waveguide 108 is of the open-wall type. The open-wall construction of the waveguide 108 allows for an acoustic exciter unit 104 to directly apply an acoustic probe to the target 103 (i.e., to shake it) with a rigid support bar 102, while simultaneously conducting EM energy in the form of EM waves to and from the target 103 along the waveguide 108. To study targets taller than a 12 oz. soda can or those with long vertical antennas (i.e., aligned parallel to the electric field of the incident radar wave), a wideband horn antenna may be substituted for the TEM cell 108.

One type of waveguide 108 useful for the embodiments herein is an open transverse electromagnetic (TEM) cell, which is used to couple the EM energy into the targets. The open-wall TEM cell 108 allows direct physical contact to be made between the target 103 and the support rod 102 driven by the acoustic exciter 104 (mechanical shaker). In the illustrated embodiment, the TEM cell 108 has a shell 170 and a septum, or middle plate, 164 suspended within the shell 170. The shell 170 includes a bottom plate 162 and a top plate 166. The middle plate 164 is positioned at about midway between the top plate 166 and the bottom plate 162. A plurality of structural bars 168 extend between the bottom plate 162 and the top plate 166 to help keep the distance between the bottom plate 162 and the top plate 166. There is a distance between the bottom plate 162 and the middle plate 164 and a distance between the middle plate 164 and the top plate 166. The plurality of structural bars 168 may also contact the middle plate 164 to help maintain the distance between the bottom plate 162 and the middle plate 164 and the distance between the middle plate 164 and the top plate 166. The spaces between the structural bars 168 provide the shell 170 with open sides or walls 122, which allow for the second end 114 of the support bar 102, having the target device 103 mounted thereto, to be located within the interior space of the waveguide 108 (TEM cell) and for changing of the orientation of support bar 102 relative to the waveguide 108.

The output 138 of the radio frequency signal generator 106 is connected to the first port 120 of the waveguide 108 (TEM cell) through the pass-through output 126 of the directional coupler 124. The output 138 of the radio frequency signal generator 106 includes a signal line and a ground line. The ground line is connected to the shell of the TEM cell 108 to ground the shell of the TEM cell, and the signal line is connected to the middle plate of the TEM cell 108, which creates an EM field between the bottom plate and the middle plate and an EM field between the middle plate and the top plate. The target device 103 attached to the second end 114 of the support bar 102 is placed either between the bottom plate and the middle plate or between the middle plate and the top plate to illuminate the target device 103 with EM energy or EM waves.

The EM-wave frequencies which may be used to illuminate the target 103 are limited chiefly by the geometry of the waveguide 108, which includes the space available to insert the target 103. A typical open TEM cell 108 large enough to fit a handheld radio is operable up to approximately 700 MHZ. The acoustic-wave frequencies which may be used to excite the target 103 are limited primarily by the output of the acoustic exciter 104. A typical acoustic exciter 104 is operable from sub-audio frequencies up to approximately 10 kHz, and such units maintain a relatively flat acoustic-power vs. frequency response.

In the illustrated embodiment, the support bar or rod 102 is a wooden dowel. The support bar 102 extends from the acoustic exciter 104 to the target 103. The support bar 102 is attached to the acoustic exciter 104 with the fastener 180 and jam nut 188 as previously described. In the illustrated embodiment, the fastener 180 is fabricated from a hex bolt and a wood screw. The hex bolt matches a threaded hole 190 in the driver member or output 178 of the acoustic exciter 104. The head of the wood screw is cut off and the threads near its head are milled away, i.e., the wood screw shaft, near where the wood screw head was formerly attached, is smoothed. The top-center of the hex bolt head is drilled and the smoothed end of the wood screw is inserted into the hole drilled in the top of the hex bolt head. Epoxy resin is applied and allowed to solidify to secure the wood screw shaft to the head of the hex bolt. A pilot hole 192 is drilled into the first end 112 of the support bar 102, which is the end of the support bar 102 nearest the acoustic exciter 104, and the wood-screw shaft portion of the fastener 180 is threaded into the pilot hole 192 to secure the fastener 180 to the support bar 102. The fastener 180 ensures a smooth transition of materials between the acoustic exciter 104 and the support bar 102 while maintaining the rigidity required to efficiently transfer mechanical energy from the output of the acoustic exciter 104 into the support bar 102.

In use, the first end 112 of the support bar 102 is connected to the driver member 178 of the acoustic exciter 104 and the second end 114 of the support bar 102 is connected to target 103 with the target 103 being placed inside the waveguide 108.

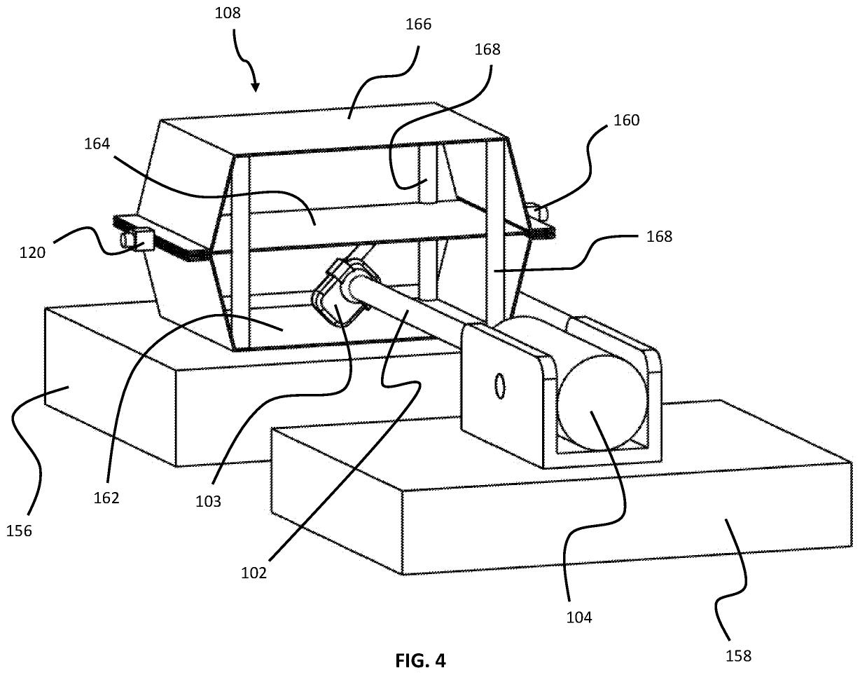

In the illustrated embodiment, the jam nut 188 is provided on the first threaded portion 182, which has machine screw threads, of the fastener 180. The target 103 may be rotated and then fixed in place, at the desired or selected rotational position about the longitudinal axis of the support bar 102 by threading the jam nut 188 closer-to or farther-from the head of the hex bolt. Thus, the acousto-EM response of the target 103 may be studied at any particular rotational position or orientation. A target 103 whose antenna is oriented at approximately 45° away from horizontal can be seen in FIG. 4. To orient the target 103 at this angle, the first threaded portion 182 of the fastener 180 is first threaded into the driver member 178 of the acoustic exciter 104 for a distance sufficient to ensure an adequately strong attachment between the driver member 178 of the acoustic exciter 104 and the support bar 102. Then, while holding the dowel and target 103 at this 45° orientation, the jam nut 188 is rotated along the first threaded portion 182 of the fastener 180 towards the acoustic exciter 104 and tightened against the driver member 178 of the acoustic exciter 104 to secure the target 103 in this orientation.

To ensure that only the target 103 shakes and the waveguide 108, and any other portion of the RF generation-and-capture equipment, does not, the waveguide 108 and acoustic exciter 104 are situated atop physically separate platforms. In the illustrated embodiment, the waveguide 108 is positioned on a first platform 156, which is a standard electronics laboratory bench, while the acoustic exciter 104 is positioned on a second platform 158, which includes vibration-absorbing or vibration-damping materials to isolate the waveguide 108 and the RF generating and processing components of the apparatus from the vibrations caused by the acoustic exciter 104. An example of a suitable second platform 158, as used in the illustrated embodiment, is a stack of Styrofoam blocks. Other materials such as, without limitation, foam rubber; neoprene; closed cell and open cell polymeric foams such as polyurethane foam, polyethylene foam, and ethylene-vinyl acetate (EVA) foam; and natural and synthetic rubber. Also, the vibration dampening or vibration isolating platforms may be provided by employing one or more of spring and damper suspension, flexible mounting hardware with rubber components to prevent rigid metal to metal connections, and rubber feet.

The acoustic exciter 104 is powered by an audio amplifier 144, into which is fed an audio-frequency signal 142 at f_{audio} provided by the audio signal generator 140. The gain of the audio amplifier 144 is adjusted to shake the target 103 with a desired maximum displacement away from its resting center position. The signal 142 is fed to the input 146 of the audio amplifier 144, and the output 148 of the audio amplifier 144 is connected to the acoustic exciter 104 in order to power the acoustic exciter 104.

In the illustrated embodiment, a rigid connection between the support bar 102 and the target 103 is established using polyester polymorphic plastic, i.e., “polymorph.” This plastic is versatile because it is easily melted (e.g. by placing 100 g in a microwave oven and heating it for approximately 10 minutes) and thereafter it is easily formed into many different shapes. Also the material may be re-melted and re-formed repeatedly. Other suitable material for forming a connection between the support bar 102 and the target 103 include, without limitation, plastics and composite materials that are solids with sufficient strength and rigidity at room temperature for this type of application and include, but are not limited to, thermoplastics; polymeric material made from a starting material that is cured or crosslinked by heat, ultraviolet light, or a curing or crosslinking agent such as, for example, two-part epoxy; and polymeric materials that are reinforced by fibers such as, for example, fiberglass, carbon-fiber composite, and other composites such as, for example, those using boron fiber, aramid fiber, or polymer fibers.

In the illustrated embodiment, the polymorph is formed into a shape which grips the second end 114 of the support bar or rod 102, which is to be placed inside the waveguide 108, as well as the target 103. In the illustrated example, pelletized (opaque) polymorph was heated (at about 160° F.) inside of a glass bowl until it was clear throughout, then the clear polymorph was spread along the rod 102 and the target 103 with a metal spatula, and the polymorph was left to cool and harden (for approximately 20 minutes), solidifying the joint between the rod 102 and the target 103. The clear, workable polymorph, is applied between and along the rod 102 and the target 103 so as to form a C-shaped strip 172 around the target 103. Also, the second end 114 of the support bar 102 is embedded in a mass 174 of the polymorph projecting outward from the middle portion of the C-shaped strip 172 to securely attach the second end 114 of the support bar 102 to the target device 103. The polymorph is then allowed to cool and harden, becoming opaque in the process. Alternatively, the polymorph may be applied in a complete loop 176 around the target device 103.

After the acoustic-excitation portion of the apparatus is fully assembled and the acoustic exciter 104 is activated, the acoustic exciter 104 vibrates the support bar 102 and the support bar 102 vibrates the target 103. As the target 103 is illuminated by RF energy at f_{RF} and vibrated at a frequency of f_{audio}, the EM wave reflected by the target 103 is sent back out the first port 120 of the waveguide 108. This backward-traveling reflection is sampled by the directional coupler 124 (usually between 6 dB and 20 dB lower than the forward-traveling illuminating RF energy at f_{RF}). The received power P_{rec} is sent from the sampling port 130 of the coupler 124 to the spectrum analyzer 132.

The values for f_{RF}, P_{RF}, f_{audio}, P_{audio}, and the set of frequencies (n values) to be captured from the target 103 may be adjusted by a computer which controls the RF signal generator 106, audio signal generator 140, and the spectrum analyzer 132.

In the illustrated embodiment, the RF signal generator 106 comprises a SIGNALHOUND™ USB-TG44A tracking generator; it outputs P_{RF}=−10 dBm. The depicted directional coupler 124 comprises a MINICIRCUITS™ ZGDC6-362HP+ which samples the signal reflected back out from the first port 120 of the waveguide 108 at −6 dB. The waveguide 108 is a commercially available TEM cell sold as the TEKBOX® TBTC3 which is operable at radio frequencies up to approximately f_{RF}=700 MHZ. The matched load 152 at the second port 160 of the waveguide 108 is 50Ω.

The illustrated audio signal generator 140 comprises a KEYSIGHT® 33210A. The illustrated audio amplifier comprises a LABWORKS™ PA-138. The illustrated acoustic exciter 104 comprises a LABWORKS™ MT-161. The polymorph plastic which attaches the support bar 102 to the target 103 comprises 100 grams of POLYIVIOLD™ Part #21-12835. The gain knob on the audio amplifier 144 was adjusted to provide a maximum target displacement of approximately ±0.5 inch. The illustrated spectrum analyzer 132 comprises a SIGNALHOUND™ USB-SA44B.

Computer control of the signal generators 106 and 140 and analyzer 132 may be accomplished in MATLAB® software with scripts written using functions from its Instrument Control Toolbox. The RF signal generator 106 and the spectrum analyzer 132 communicate with the computer over the Universal Serial Bus (USB). The audio signal generator 140 communicates with the computer using the General Purpose Interface Bus (GPM). Power vs. frequency traces for different targets and different combinations of f_{RF} and f_{audio} are stored in “.mat” files (native to MATLAB®, for recalling data vectors which would otherwise be erased by closing MATLAB®).

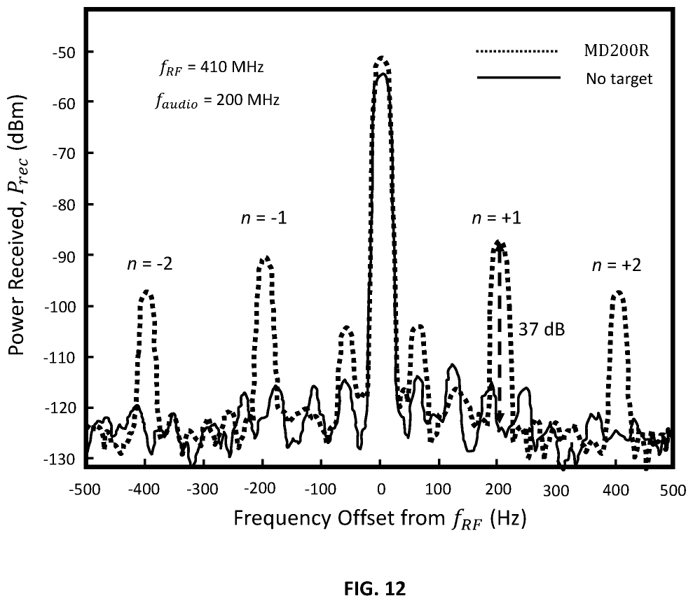

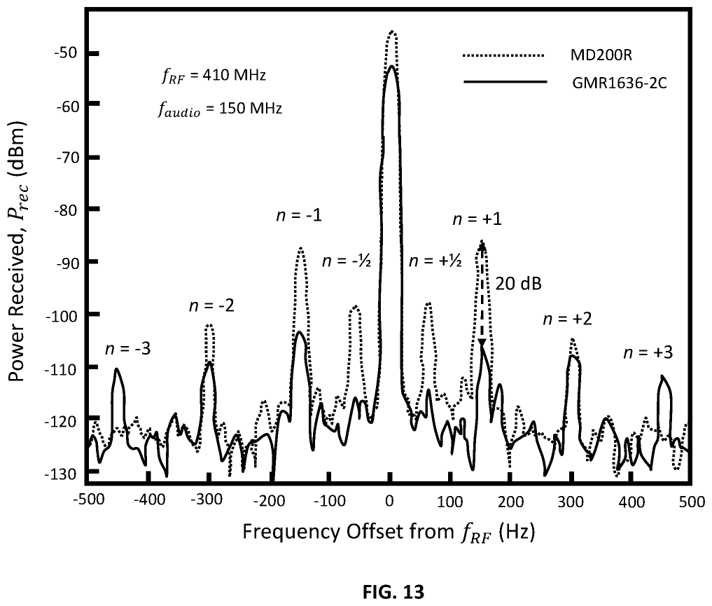

The MOTOROLA® MD200R handheld radio and the UNIDEN® GMR1636-2C handheld radio were used as sample electronic target devices 103. Sample data was recorded using these electronic targets, which are shown in FIGS. 12 and 13.

FIG. 12 contains two spectra overlaid; the dotted-line spectrum was recorded with the Motorola® radio attached to the end of the support bar 102 in the waveguide 108, and the solid-line spectrum was recorded without a target attached to the support bar 102. Both spectra were recorded for f_{RF}=410 MHZ and f_{audio}=200 MHZ. There is a clear difference between the two spectra. For example, at n=+1 the acousto-EM response from the MD200R is approximately −88 dBm while the no-target response (system noise) is approximately −125 dBm. The difference between the target-present and target-absent cases is approximately 37 dB. As the target-present response is nearly four orders of magnitude stronger than the target-absent response, the electronic target 103 is clearly detected using these particular values of f_{RF} and f_{audio}.

FIG. 13 contains another two spectra overlaid; the dotted-line spectrum was recorded with the same Motorola® radio attached to the support bar 102, and the solid-line spectrum was recorded with the Uniden GMR1636-2C attached to the support bar 102. Both spectra were recorded for f_{RF}=410 MHZ and f_{audio}=150 MHz. Both targets produce a measurable acousto-EM response at n=±1 and n=±2. However, the response from the MD200R is 20 dB higher than the GMR1636-2C at n=+1. Also, at n=+3, the response from the MD200R is under the system noise (less than ˜120 dBm) while the response from the GMR1636-2C is approximately −111 dBm. The differences between the spectra recorded from different targets probed by the same frequencies (at the same power levels, and in the same orientation) indicates that the amplitude of Pᵣₑₛ recorded at different values of n forms a unique target signature. Such signatures, if catalogued for many different targets probed by many different combinations of f_{RF} and f_{audio}, may be used to condition an algorithm to perform target recognition when the target responses are recorded by a standoff acoustic radar.

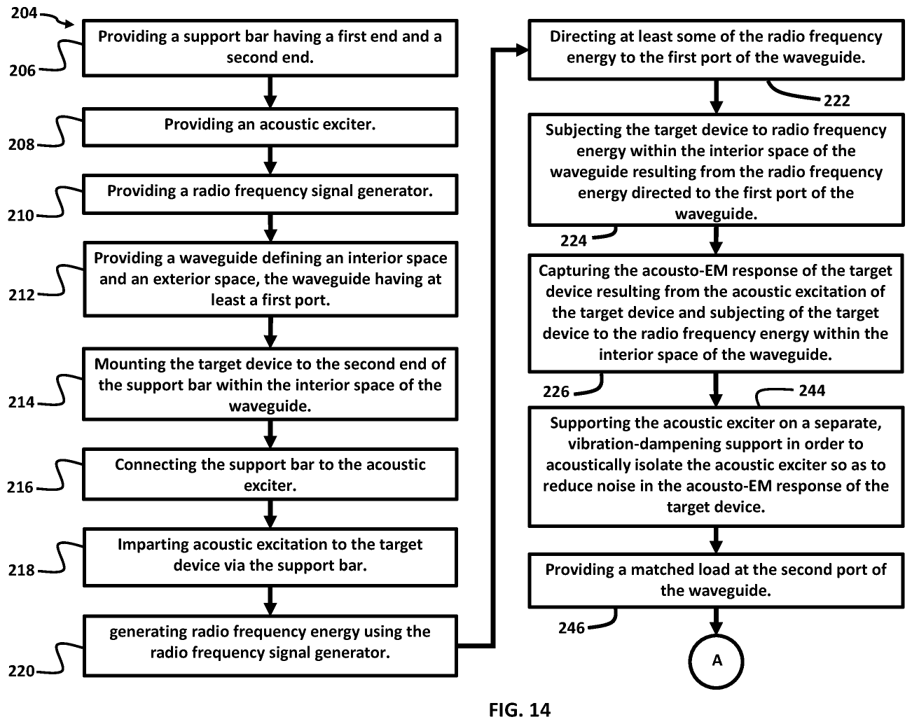

Some embodiments herein are directed to methods for characterizing the acousto-EM response of a target device 103. The target device 103 comprises at least one of the members of the group consisting of metals, electrical components, and electronic components. Referring to FIGS. 14-20, a method (204) for characterizing the acousto-EM response of a target device 103, according to an embodiment herein, includes providing (206) a support bar 102 having a first end 112 and a second end 114. The method (204) also includes providing (208) an acoustic exciter 104 and providing (210) a radio frequency signal generator 106. The method (204) also includes providing (212) a waveguide 108 defining an interior space and an exterior space, the waveguide 108 having at least a first port 120. The waveguide 108 also has at least one opening configured to allow the second end 114 of the support bar 102 to be located within the interior space of the waveguide 108 while allowing the first end 112 of the support bar 102 to be located outside of the waveguide 108. The method (204) also includes mounting (214) the target device 103 to the second end 114 of the support bar 102 within the interior space of the waveguide 108. The method (204) also includes connecting (216) the support bar 102 to the acoustic exciter 104.

The method (204) also includes imparting (218) acoustic excitation to the target device 103 via the support bar 102. The method (204) also includes generating (220) radio frequency energy using the radio frequency signal generator 106. The method (204) also includes directing (222) at least some of the radio frequency energy to the first port 120 of the waveguide 108. The method (204) also includes subjecting (224) the target device 103 to radio frequency energy within the interior space of the waveguide 108 resulting from the radio frequency energy directed to the first port 120 of the waveguide 108. The method (204) also includes capturing (226) the acousto-EM response of the target device 103 resulting from the acoustic excitation of the target device 103 and subjecting of the target device 103 to the radio frequency energy within the interior space of the waveguide 108.

In some embodiments, directing (222) at least some of the radio frequency energy from the radio frequency signal generator 106 to the first port 120 of the waveguide 108 includes providing (228) a directional coupler 124 having a pass-through output 126 that is connected to the first port 120 of the waveguide 108. Directing (222) at least some of the radio frequency energy from the radio frequency signal generator 106 to the first port 120 of the waveguide 108 is accomplished at least in part by using the directional coupler 124. The directional coupler 124 has a sampling port 130. The acousto-EM response of the target device 103 comprises radio frequency energy reflected by the target device 103, and the radio frequency energy reflected by the target device 103 is sampled through the sampling port 130 of the directional coupler 124 to capture the acousto-EM response of the target device 103. Accordingly, in some embodiments herein, directing (222) at least some of the radio frequency energy from the radio frequency signal generator 106 to the first port 120 of the waveguide 108 further comprises directing (230) at least some of the radio frequency energy from the radio frequency signal generator 106 to the first port 120 of the waveguide 108 through the pass-through output 126 of the directional coupler 124.

In some embodiments, capturing (226) the acousto-EM response of the target device 103 comprises providing (232) a spectrum analyzer 132 in communication with the sampling port 130 of the directional coupler 124 to capture the acousto-EM response of the target device 103. The acousto-EM response of the target device 103 is captured in the form of a power received by the spectrum analyzer 132 vs. frequency spectrum. The power received by the spectrum analyzer 132 is based at least in part on a rate per unit time at which the radio frequency energy reflected by the target device 103 is received by the spectrum analyzer 132 through the sampling port 130 of the directional coupler 124. Accordingly, in some embodiments herein, capturing (226) the acousto-EM response of the target device 103 further comprises receiving (234) the radio frequency energy reflected by the target device 103 at the spectrum analyzer 132 through the sampling port 130 of the directional coupler 124.

The support bar 102 has a longitudinal axis, and the support bar 102 is connected to the acoustic exciter 104 using a connection configured to allow rotation of the support bar 102 about its longitudinal axis to a user-selectable angle to allow for changing an angle of the target device 103 relative to a reference plane containing the longitudinal axis of the support bar 102. The angle of the target device 103 relative to a reference plane containing the longitudinal axis of the support bar 102 resulting from the rotation of the support bar 102 and the target device 103 about the longitudinal axis of the support bar 102 is also referred to herein as the rotational position of the target device 103 about the longitudinal axis of the support bar 102.

The support bar 102 also has an orientation relative to the waveguide 108, which is defined by the angles of the longitudinal axis of the support bar 102 relative to the x, y, and z axes of three dimensional space. The waveguide 108 is an open wall waveguide that allows for changing of the orientation of the support bar 102 relative to the waveguide 108 in order to determine the acousto-EM response of the target device 103 at a variety of angular orientations of the target device 103 relative to a direction of propagation of the radio frequency energy within the waveguide 108.

In some embodiments, the method (204) may further comprise repeating (236), for a plurality of rotational positions of the target device 103 about the longitudinal axis of the support bar 102, at least mounting (214) the target device 103 to the second end 114 of the support bar 102, imparting (218) acoustic excitation to the target device 103 via the support bar 102, generating (220) radio frequency energy using the radio frequency signal generator 106, subjecting (224) the target device 103 to radio frequency energy, and capturing (226) the acousto-EM response of the target device 103.

In some embodiments, the method (204) may further comprise repeating (238), for a plurality of orientations of the support bar 102 relative to the waveguide 108, at least mounting (214) the target device 103 to the second end 114 of the support bar 102, imparting (218) acoustic excitation to the target device 103 via the support bar 102, generating (220) radio frequency energy using the radio frequency signal generator 106, subjecting (224) the target device 103 to radio frequency energy, and capturing (226) the acousto-EM response of the target device 103.

In some embodiments, the acousto-EM response is determined for a plurality of different, i.e., dissimilar, target devices to create a library of target device responses for future use in identifying target devices using acoustic/electromagnetic radar. Accordingly, the method (204) further comprises repeating (240), for a plurality of dissimilar target devices 103, at least mounting (214) the target device 103 to the second end 114 of the support bar 102, imparting (218) acoustic excitation to the target device 103 via the support bar 102, generating (220) radio frequency energy using the radio frequency signal generator 106, subjecting (224) the target device 103 to radio frequency energy, and capturing (226) the acousto-EM response of the target device 103; and creating (241) a library of target device responses for future use in identifying target devices using acoustic/electromagnetic radar.

In some embodiments, providing (206) a support bar 102 comprises providing (242) a support bar 102 made of a non-metallic material having low reflectivity with respect to radio frequency energy.

In some embodiments, the method (204) further comprises supporting (244) the acoustic exciter 104 on a separate, vibration-dampening support in order to acoustically isolate the acoustic exciter 104 from the other components of the apparatus, such as the waveguide 108 and the spectrum analyzer 132 for example, so as to reduce noise in the acousto-EM response of the target device 103 received by the spectrum analyzer 132.

In some embodiments herein, the waveguide 108 has a second port 160, and the method (204) further comprises providing (246) a matched load 152 at the second port 160 of the waveguide 108. In some embodiments, mounting (214) the target device 103 to the second end 114 of the support bar 102 may further include attaching (248) the target device 103 to the second end 114 of the support bar 102 using a polymer material that is hard at room temperature and that is applied in a strip around the target device 103 with a mass of the polymer material at the back side of the strip of polymer material in which the second end 114 of the support bar 102 is embedded, and providing (250) for the strip of polymer material to extend around the target device 103 so as to form one of a C-shaped strip and an endless loop strip.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method for characterizing the acousto-EM response of a target device comprising at least one member of a group consisting of metals, electrical components, and electronic components, the method comprising:
providing a support bar having a first end and a second end;
providing an acoustic exciter;
providing a radio frequency signal generator;
providing a waveguide defining an interior space and an exterior space, the waveguide having at least a first port, the waveguide having at least one opening configured to allow the second end of the support bar to be located within the interior space of the waveguide while allowing the first end of the support bar to be located outside of the waveguide;
mounting the target device to the second end of the support bar within the interior space of the waveguide;
connecting the support bar to the acoustic exciter;
imparting acoustic excitation to the target device via the support bar;
generating radio frequency energy using the radio frequency signal generator;
directing at least some of the radio frequency energy to the first port of the waveguide;
subjecting the target device to radio frequency energy within the interior space of the waveguide resulting from the radio frequency energy directed to the first port of the waveguide; and
capturing the acousto-EM response of the target device resulting from the acoustic excitation and subjecting of the target device to the radio frequency energy within the interior space of the waveguide.

2. The method of claim 1, wherein directing at least some of the radio frequency energy from the radio frequency signal generator to the first port of the waveguide comprises:
providing a directional coupler having a pass-through output that is connected to the first port of the waveguide; and
directing at least some of the radio frequency energy from the radio frequency signal generator to the first port of the waveguide through the pass-through output of the directional coupler.

3. The method of claim 2, wherein the directional coupler has a sampling port, wherein the acousto-EM response of the target device comprises radio frequency energy reflected by the target device, and wherein the radio frequency energy reflected by the target device is sampled through the sampling port of the directional coupler to capture the acousto-EM response of the target device.

4. The method of claim 3, further comprising:
providing a spectrum analyzer in communication with the sampling port of the directional coupler to capture the acousto-EM response of the target device, wherein the acousto-EM response of the target device is captured in the form of a power received by the spectrum analyzer vs. frequency spectrum, wherein the power received by the spectrum analyzer is based at least in part on a rate per unit time at which the radio frequency energy reflected by the target device is received by the spectrum analyzer through the sampling port of the directional coupler, and wherein capturing the acousto-EM response of the target device comprises receiving the radio frequency energy reflected by the target device at the spectrum analyzer through the sampling port of the directional coupler.

5. The method of claim 4, wherein the support bar has a longitudinal axis, and wherein the support bar is connected to the acoustic exciter using a connection configured to allow rotation of the support bar about its longitudinal axis to a user-selectable angle to allow for changing an angle of the target device relative to a reference plane containing the longitudinal axis of the support bar.

6. The method of claim 5, wherein the support bar has an orientation relative to the waveguide, wherein the waveguide is an open wall waveguide that allows for changing of the orientation of support bar relative to the waveguide in order to determine the acousto-EM response of the target device at a variety of angular orientations of the target device relative to a direction of propagation of the radio frequency energy within the waveguide, and wherein the acousto-EM response is determined for a plurality of different target devices to create a library of target device responses for future use in identifying target devices using acoustic/electromagnetic radar.

7. The method of claim 1, further comprising supporting the acoustic exciter on a separate, vibration-dampening support in order to reduce noise in the acousto-EM response of the target device received by the spectrum analyzer, wherein the waveguide has a second port, and wherein the method further comprises providing a matched load at the second port of the waveguide.

8. The method of claim 7, wherein mounting the target device to the second end of the support bar further comprises:
attaching the target device to the second end of the support bar using a polymer material that is hard at room temperature and that is applied in a strip around the target device with a mass of the polymer material at the back side of the strip of polymer material in which the second end of the support bar is embedded; and
providing for the strip of polymer material to extend around the target device so as to form one of a C-shaped strip and an endless loop strip.

9. An apparatus for characterizing the acousto-EM response of a target device comprising at least one member of a group consisting of metals, electrical components, and electronic components, the apparatus comprising:
a support bar having a first end and a second end;
an acoustic exciter;
a radio frequency signal generator;
a waveguide defining an interior space and an exterior space, the waveguide having at least a first port, the waveguide having at least one opening configured to allow the second end of the support bar to be located within the interior space of the waveguide while allowing the first end of the support bar to be located outside of the waveguide,
wherein the second end of the support bar is capable of having the target device mounted thereto within the interior space of the waveguide,
wherein the support bar is connected to the acoustic exciter such that the acoustic exciter can impart acoustic excitation to the target device via the support bar, and
wherein the radio frequency signal generator is configured for generating radio frequency energy, and wherein at least some of the radio frequency energy is directed to the first port of the waveguide in order to subject the target device to radio frequency energy within the interior space of the waveguide resulting from the radio frequency energy directed to the first port of the waveguide when the target device is mounted to the second end of the support bar within the interior space of the waveguide; and
means for capturing the acousto-EM response of the target device resulting from the acoustic excitation and subjecting of the target device to the radio frequency energy within the interior space of the waveguide.

10. The apparatus of claim 9, further comprising:
a directional coupler having a pass-through output that is connected to the first port of the waveguide, wherein the directional coupler directs at least some of the radio frequency energy from the radio frequency signal generator to the first port of the waveguide.

11. The apparatus of claim 10, wherein the directional coupler has a sampling port, wherein the acousto-EM response of the target device comprises radio frequency energy reflected by the target device when the target device is mounted to the second end of the support bar within the interior space of the waveguide, and wherein the radio frequency energy reflected by the target device is sampled through the sampling port of the directional coupler to capture the acousto-EM response of the target device.

12. The apparatus of claim 11, further comprising:
a spectrum analyzer in communication with the sampling port of the directional coupler to capture the acousto-EM response of the target device when the target device is mounted to the second end of the support bar within the interior space of the waveguide, wherein the spectrum analyzer is configured to capture the acousto-EM response of the target device in the form of a power received by the spectrum analyzer vs. frequency spectrum, and wherein the power received by the spectrum analyzer is based at least in part on a rate per unit time at which the radio frequency energy reflected by the target device is received by the spectrum analyzer through the sampling port of the directional coupler.

13. The apparatus of claim 12, wherein the support bar has a longitudinal axis, and wherein the support bar is connected to the acoustic exciter using a connection configured to allow rotation of the support bar about its longitudinal axis to a user-selectable angle to allow for changing an angle of the target device relative to a reference plane containing the longitudinal axis of the support bar.

14. The apparatus of claim 13, wherein the support bar has an orientation relative to the waveguide, and wherein the waveguide is an open wall waveguide that allows for changing of the orientation of support bar relative to the waveguide in order to determine the acousto-EM response of the target device at a variety of angular orientations of the target device relative to a direction of propagation of the radio frequency energy within the waveguide.

15. The apparatus of claim 14, wherein support bar is made of a non-metallic material having low reflectivity with respect to radio frequency energy.

16. The apparatus of claim 15, further comprising a separate, vibration-dampening support, wherein the acoustic exciter is supported on the separate, vibration-dampening support in order to acoustically isolate the spectrum analyzer from the acoustic exciter so as to reduce noise in the acousto-EM response of the target device received by the spectrum analyzer, and wherein the waveguide has a second port and a matched load provided at the second port of the waveguide.

17. The apparatus of claim 9, wherein the support bar is made of a non-metallic material having low reflectivity with respect to radio frequency energy and is made from one or more materials selected from the group consisting of wood, polymers, and non-metallic composite material.

18. The apparatus of claim 9, wherein the connection configured to allow rotation of the support bar about its longitudinal axis is provided at least in part by a fastener made of a composite of metallic and non-metallic materials.

19. The apparatus of claim 9, wherein the fastener has a longitudinal axis, wherein the fastener comprises a first threaded portion, a second threaded portion, and a middle portion provided intermediate the first threaded portion and the second threaded portion, wherein the first threaded portion and the second threaded portion are coaxial, wherein the first threaded portion is provided with machine screw threads, wherein the second threaded portion is provided with wood screw threads, and wherein the middle portion is adapted for engagement by a tool for rotating the fastener about the longitudinal axis of the fastener.

20. An apparatus for characterizing the acousto-EM response of a target device comprising at least one member of a group consisting of metals, electrical components, and electronic components, the apparatus comprising:
a support bar having a first end and a second end;
an acoustic exciter;
a radio frequency signal generator;
a waveguide having at least a first port,
wherein the second end of the support bar is capable of having the target device mounted thereto,
wherein the support bar is connected to the acoustic exciter such that the acoustic exciter can impart acoustic excitation to the target device via the support bar, and
wherein the radio frequency signal generator is configured for generating radio frequency energy, and wherein at least some of the radio frequency energy is directed to the first port of the waveguide in order to subject the target device to radio frequency energy resulting from the radio frequency energy directed to the first port of the waveguide when the target device is mounted to the second end of the support bar;
a directional coupler having an input that is in communication with the radio frequency signal generator, the directional coupler having a pass-through output that is connected to the first port of the waveguide, wherein the directional coupler directs at least some of the radio frequency energy from the radio frequency signal generator to the first port of the waveguide,
wherein the directional coupler has a sampling port, wherein the acousto-EM response of the target device comprises radio frequency energy reflected by the target device when the target device is mounted to the second end of the support bar and subjected to acoustic excitation and radio frequency energy via the waveguide;
a spectrum analyzer having an input port in communication with the sampling port of the directional coupler to receive the acousto-EM response of the target device, wherein the spectrum analyzer has an output port, wherein the spectrum analyzer is configured to provide the acousto-EM response of the target device in the form of a power received by the spectrum analyzer vs. frequency spectrum at the output port of the spectrum analyzer, and wherein the power received by the spectrum analyzer is based at least in part on a rate per unit time at which the radio frequency energy reflected by the target device is received by the spectrum analyzer through the sampling port of the directional coupler; and
a signal recorder communicating with the output of the spectrum analyzer for capturing the acousto-EM response of the target device, in the form of the power received by the spectrum analyzer vs. frequency spectrum, resulting from the acoustic excitation of the target device and subjecting of the target device to the radio frequency energy via the waveguide.
